(19) United States
(12) Patent Application Publication
(10) Pub. No.: US 2014/0168094 A1
(43) Pub. Date: Jun. 19, 2014

(54) TANGIBLE ALPHANUMERIC INTERACTION ON MULTI-TOUCH DIGITAL DISPLAY

(71) Applicants: Robin Duncan Milne, Auckland (NZ); Anna Kirschberg, Auckland (NZ)

(72) Inventors: Robin Duncan Milne, Auckland (NZ); Anna Kirschberg, Auckland (NZ)

(21) Appl. No.: 13/714,884

(22) Filed: Dec. 14, 2012

(51) Int. Cl. G06F 3/01

(52) U.S. Cl. CPC G06F 3/017
USPC 345/173

(57) ABSTRACT

A method and system of using a tangible object with a with screen display device to enhance a user's experience while operating the touch screen display device. The tangible object may be placed oaths touch screen display device by the user and the unique attributes may be detected by the touch screen display device's built-in detection/sensing capabilities and processed as an input to a program or app. running on the touch screen display device. In this regard, various aspects of the present invention are directed toward providing a tangible feature to touch screen display operation to provide a more interactive experience when using a touch screen display, especially for young children.

### CROSS-REFERENCE TO RELATED APPLICATIONS

Not Applicable

### STATEMENT RE: FEDERALLY SPONSORED RESEARCH DEVELOPMENT

Not Applicable

### BACKGROUND

1. Technical Field of the Invention

The present invention relates generally to a method and system of integrating tangible objects with touch screen display devices for use as inputs when operating an educational or recreational application on the touch screen display device.

2. Description of the Related Art

Tablet computers are gaining in popularity due to their compact configuration, ease of use and transport, and attractive price point relative to more robust computing systems. Tablet computers are very useful and may be employed as an entertainment tool as well as a learning tool. Exemplary tablet computers include the iPad™ by Apple Inc. or the Galaxy™ by Samsung Electronics.

Tablet computers typically operate via a touch screen user interface wherein the display screen serves dual functions of displaying visual content as well as receiving user input. Along these lines, the touch screen display is generally configured to allow a user to physically interact therewith for making gestures to make selections, navigate through menus, scroll through content, type on a digital keypad, zoom in/out, or make other user inputs. In this regard, marry tablet computers are configured to operate independent of a conventional keypad or mouse.

Many conventional touch screens employ resistive or capacitive technology for detecting a user input. Most resistive touch screens use a voltage drop to detect the coordinates of the user input. More specifically, when a user touches a resistive touch screen, the conduction state of a loop may be turned on and a voltage drop occurs. A processor inside of the tablet computer calculates the proportion of the voltage drop to determine the coordinates of the touched point. Most capacitive touch screens use charge variation to detect the coordinates of the user input. In particular, when a user touches a capacities touch screen, a processor in the tablet computer calculates the proportion of the charge carried away by a conductor, such as a linger of the user) to determine the coordinates of the touched point.

Tablet computers are used by children of all ages as recreational and educational tools. There are a wide range of applications (i.e., “apps”) which may be downloaded onto the tablet computer or accessed by the tablet computer for use by a child user. An exemplary educational app. may include depicting several shapes on the display and asking the child user to “touch” a certain shape shown on the touch screen. If the user “touches” the correct shape, the tablet computer may display an image such as a star along with the word “CORRECT.” On the other hand, if the user makes an incorrect selection, the tablet computer may depict the words “TRY AGAIN.” A recreational app. may include a traditional tic-tac-toe game wherein a user selects virtual X's and O's for -placement within a virtual grid.

One deficiency commonly associated with the aforementioned recreational and educational apps. is that the app. is primarily two-dimensional. In other words, the app. is primarily virtual and does nor include any tangible aspect, other than the tablet computer. The primarily virtual nature of the apps. may cause child users to become bored or disinterested in a short period of time.

Therefore, there is a need in the art for an improved method and system of using touch screen display devices which integrate tangible objects with the touch screen display device when using virtual apps. Various aspects of the present invention address these particular needs, as will be discussed in more detail below.

### BRIEF SUMMARY

There is provided a method and system of using a tangible object with a touch screen display device to enhance a user's experience while operating the touch screen display device. The tangible object may be placed on the touch screen display device by the user and the unique attributes may be detected by the touch screen display device's built-in detection/sensing capabilities and processed as an input to a program or app. running on the touch screen display device. In this regard, various aspects of the present invention are directed toward providing a tangible feature to touch screen display operation to provide a more interactive experience when using a touch screen display, especially for young children.

One embodiment relates to a method of using a tangible object with a touch screen display device. The tangible object includes contact points which define a unique sensing pattern, and the touch screen display device includes a touch screen display. The method includes the steps of providing a character recognition database having a plurality of stored sensing patterns associated with respective alphanumeric characters. The method farther includes defecting the sensing pattern of a tangible object defined by the contact points of a tangible object contacting the touch screen display, wherein the detecting is performed by the touch screen display device. The method additionally includes cross referencing the detected sensing pattern with the plurality of sensing patterns in the character recognition database to identify the alphanumeric character associated with the tangible object contacting the touch screen display. The method further includes generating an output by the touch screen display device in response to detection of the sensing pattern of the tangible object.

The generating step may include emitting a visual output on the touch screen display of an image corresponding to the tangible object contacting the touch screen display. The generating step may further include emitting an audible signal on the touch screen display in response to detection of the tangible object.

The tangible object may correspond to an alphanumeric character, symbol, object, animal, punctuation, etc.

The method may additionally include the step of displaying a first image on the touch screen display prior to the detecting step. The first image may be an algebraic expression having a missing term. The method may further include the step of determining whether the alphanumeric character associated with the tangible object corresponds to the missing term. The first image may also be a word having a missing letter. The method may further include the step of determining whether the alphanumeric character associated with the tangible object corresponds to the missing letter.

The generating step may include emitting a visual signal including a second image associated with the word.

The method may further include the step of defining a reference coordinate system relative to the touch screen display, and determining whether the tangible object is aligned with the coordinate system.

The method may additionally include the step of displaying a contact zone on the touch screen display, wherein the tangible object is detectable when contacting the touch screen display within the contact zone and non-detectable when contacting the touch screen outside of the contact zone.

The method may further include the steps of displaying, an image on the touch screen display, and determining whether the sensing pattern of the tangible object contacting the touch screen display matches the image displayed on the touch screen display.

The detecting step may include detecting conductive touch points on the tangible object using the touch screen display.

The method may include providing a symbol recognition database having a plurality of stored sensing patterns associated with respective symbols, and the cross referencing stop may include cross referencing the detected sensing pattern with the plurality of sensing patterns in the character recognition database to identify the symbol associated with the tangible object contacting the touch screen display.

According to another aspect of the present invention, there is provided a method of using a tangible object having a unique sensing pattern with a touch screen display. The method includes providing a sequence database having a plurality of sensing pattern sequences stored therein. Each sensing pastern sequence includes a first sensing pattern and a second sensing pattern associated with respective alphanumeric characters or symbols. The method additionally includes detecting the sensing pattern of a first tangible object contacting the touch screen display and detecting the sensing pattern of a second tangible object contacting the touch screen display. The method further includes cross referencing the sequence database with the sensing patterns of the first and second tangible objects to determine whether the sequence patterns of the first and second tangible objects match any of the plurality of sensing pattern sequences stored in the sequence database.

The method may additionally include the steps of emitting a first signal in response to determining that the sequence patterns of the first and second tangible objects match at least one of the plurality of sensing pattern sequences stored in the sequence database, and emitting a second signal in response to determining that the sequence patterns of the first and second tangible objects do not match any of the plurality of sensing pattern sequences stored in the sequence database.

The first and second tangible objects may simultaneously contact the touch screen display.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is an exploded lower perspective view of an exemplary embodiment of a tangible object constructed for use with a touch screen display;

FIG. 1B is a cross sectional view of the tangible abject depicted in FIG. 1A;

FIG. 2 is a top view of a tangible object having a lion depicted, thereon placed on the touch screen display;

FIG. 3 is a top view of an algebraic expression formed using tangible objects placed on and detected by the touch screen display device, with the touch screen display device depicting a “CORRECT” image in response thereto;

FIG. 4A is a top view of a user placing the tangible object from FIGS. 1A-1B on a touch screen display device in accordance with an aspect of the present invention;

FIG. 4B is a top view of the tangible object correctly placed on the touch screen display device, with the touch screen display device depicting an image of a hat in response thereto; and

FIG. 5 is a block diagram of the components of a touch screen display device utilized in accordance with an embodiment of the present invention.

Common reference numerals are used throughout the drawings and detailed description to indicate like elements.

### DETAILED DESCRIPTION

The detailed description set forth below is intended as a description of the presently preferred embodiment of the invention, and is nor intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, wherein the showings are for purposes of illustrating preferred embodiments of the present invention only, and not for purposes of limiting the same, there is depicted a method and system for uniquely and advantageously using a tangible object 10 with a touch screen display device 12, such as an iPad™, IPhone™, other tablet computing devices or smart phones. The method and system allow for recognition of the tangible object 10 by the touch screen display device 12 such that the touch screen display device 12 generates an output in response to recognition of the tangible object 10. As will be described in more detail below, the output may be a visual, audible, or a combination thereof (i.e., visual and audible). Various aspects of the present invention may be specifically adapted as educational tools or entertaining games for children of all ages. Along these lines, the use of the tangible object 10 creates a physical component to an otherwise virtual game or program, and thereby more readily captivates the user's attention.

A tangible object 10 may be configured in a variety of shapes and sizes. The physical configuration of the tangible object 10 may correspond to a letter, a number, a mathematical operator (such as a multiplication sign “×” or a division sign “÷”), an animal, an object (such as a hat, cloud, tree, etc.), a game piece, a grammatical sign, grouping of letters, grouping of numbers, clocks, or anything else known or contemplated by those skilled in the art. Alternatively, the tangible object 10 may define a generic shape (such as a rectangular shape), and have an associated alphanumeric character, symbol, object, or the like depicted thereon.

According to one embodiment, the tangible object 10 is a tangible user interlace component (TUIC) that is a three piece construction including a skin cover 14, a conductive foam or rubber layer 16, and a non-conductive foam or rubber layer 18. The cover skin 14 may be fabricated from a durable material and may extend over the upper outer surfaces of the tangible object 10 to protect the tangible object 10 during use, such as from exposure to liquids, etc. The conductive layer 16 may include one or more touch points or contact points 20 arranged in a unique sensing pattern. The contact points 20 may be placed at pre-defined distance and angle configurations to make the patterns distinguishable from each other, as well as from human touch or gestures. The sensing pattern may also be defined by the number of contact points 20, the size of the contact points 20, including the diameter or surface area of the contact points 20, the shape of the contact points 20, or other characteristics of the contact points 20. The contact points 20 extend through respective apertures 21 formed in the non-conductive foam or rubber layer 18. The distal end of the contact points 20 may be flush with the exposed outer surface of the non-conductive foam or rubber layer 18, or alternatively, the distal end of the contact points 20 may protrude through the apertures 21 and beyond the exposed outer surface of the non-conductive foam or rubber layer 18.

Some capacitive multi-touch devices (i.e., touch screen display devices 12) have a limit on the total number of concurrent touch points they can detect. For instance, many models of the iPad™ limit the total number of concurrent (ouch points to ten, while other devices have been known to detect up to thirty concurrent touch points. This limitation may place a limit on the total number of contact points 20 on each tangible object 10 (i.e., the number of contact points 20 on the tangible object 10 should not exceed the maximum number of concurrent touch points detectable by the touch screen display device 12). In addition, there may be a minimum distance required between each contact point 20. For Instance, some iPads™ require at least 0.5 cm between contact points. Thus, the contact points 20 on the tangible objects 10 may be configured to accommodate the spacing requirements of the touch screen display device 12.

According to one implementation each tangible object 10 defines at least one dimension that is 2 cm, and includes between four and ten contact points 20. However, those skilled in the art will recognize that other embodiments of the tangible object 10 may include fewer than four or more than ten contact points 20. Along these lines, the configuration of the tangible object 10 enables object identification, sensing and tracing on unmodified capacitive multi-touch panels by simulating and recognizing multi-touch gestures.

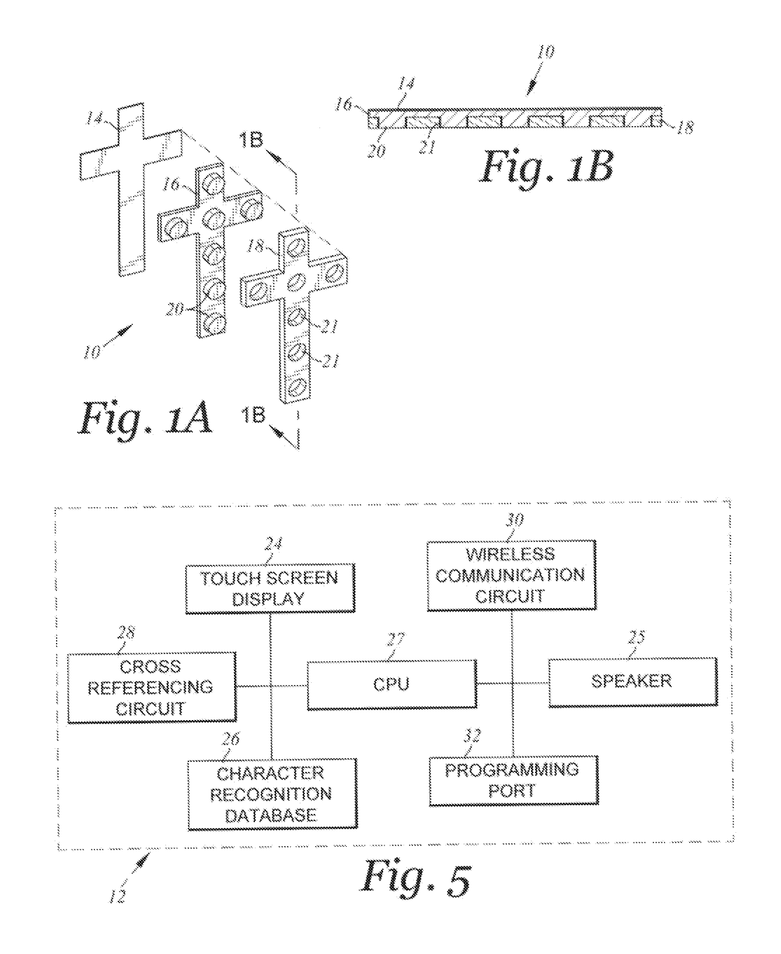

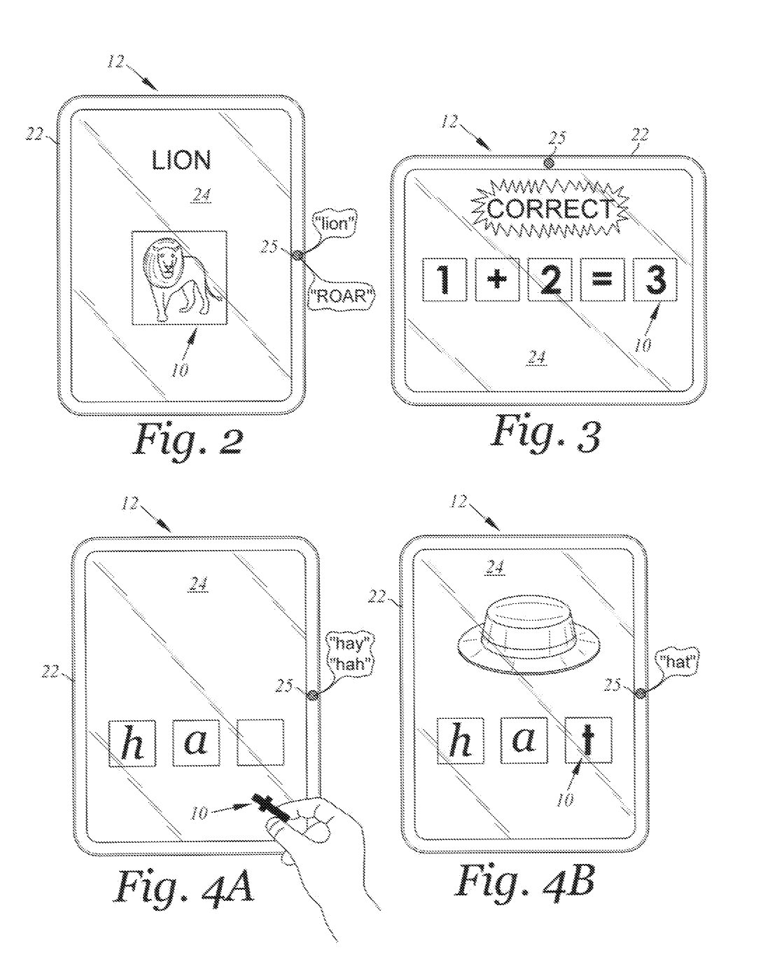

In the exemplary embodiment shown in FIGS. 1A, 1B, 2A and 2B, the tangible object 10 is in the shape of a lower case “t, ” and includes two arrays of contact points 20 arranged along substantially orthogonal axes. In the first, vertical array, there are five contact points 20, while in the second horizontal array there are three contact points 20, with the horizontal and vertical arrays sharing one contact point 20.

It is contemplated that the contact points 20 may be arranged in several different configurations, depending on the shape of the tangible object 10 and the associated alphanumeric symbol or object. For example, the letter O may correspond to contact points 20 arranged in a circle, while the letter V may include contact points 20 arranged in two linear arrays intersecting in a non-orthogonal arrangement. Although it may be preferable to arrange the contact points 20 in a sensing pattern that corresponds to the tangible object 10 (i.e. contact points 20 arranged in intersecting arrays for the letter T), it is not necessary that the sensing pattern of the contact points 20 directly corresponds to the tangible object 10. For instance, the tangible object 10 may correspond to an animal such as a dog, and the contact points 20 may be arranged in an arbitrary yet unique pattern which may be detected by the touch screen display device 12 to identify the tangible object 10 as relating to a dog.

Referring now specifically to FIGS. 2A-5, various embodiment of the touch screen display device 12 include a body 22 and a touch screen display 24. The body 22 houses the internal components of the touch screen display device 12, exemplary ones of which are shown in FIG. 5, while the touch screen display 24 is the portion of the touch screen display device 12 which displays images as well as detects inputs from objects interfacing or contacting with the touch screen display 24.

The touch screen display 24 may employ any sensing or detecting technology known in the art. For instance, the touch screen display 24 may be a resistive touch screen which uses voltage drop to detect the existence and position of the input, or a capacitive touch screen which uses charge variation to detect the existence and position of the input to the touch screen display 24. Many multi-touch devices (i.e., touch screen display devices 12) are generally made by projected capacitive technology (PCT). In most multi-touch devices, a single conductive layer of X-Y grid or two separate orthogonal conductive layers arte etched on a projected capacitive touch panel. The multi-touch controller of PCT senses changes at each point along the grid. Every point along the grid generates its own signal and generates multi-touch points to the system.

The system further includes a character recognition database 26 having a plurality of stored sensing patterns associated with various tangible objects 10. For instance, the storage sensing patterns may be associated with alphanumeric character, symbols, objects, etc. associated with the tangible object. The character recognition database 26 is preferably stored locally within the touch screen display device 12. For instance, the character recognition database 26 may be part of a downloadable tablet computer or smart phone application (i.e., “an app”). The app. may be downloaded wirelessly via a wireless communication, circuit 30, or through a wired connection via a programming port 32. The app. may be free or available by paying a fee. It is also contemplated that the character recognition database 26 may be located remotely from the touch screen display device 12 and accessed via the Internet. In this regard, a single character recognition data base 26 may be bested at the remote location and accessed by a plurality of touch screen display devices 12 having access rights thereto. Such access rights may be gained by paying a fee to the host of the character recognition database 26.

With the basic features of the system described above, the following discussion generally pertains to usage of the system. A tangible object 10 is played on the touch screen display 24 such that the contact points 20 interface or contact with the touch screen display 24. The touch screen display 24 is configured to detect the sensing pattern of the tangible object 10 defined by the contact points 20 of the tangible object 10 interfacing with or contacting the touch screen display 24. It is preferred that the detecting is performed by the touch screen display device 12.

According to one embodiment, to recognize the unique sensing pattern of a tangible object 10, the first stage is to verity that the number of contact points 20 is greater than or equal to four. This assumes that each tangible object 10 has at least four contact points 20, although, as noted above, other implementations of the present invention may include tangible objects 10 with fewer than four contact points 20.

The detected sensing pattern is then cross referenced with the plurality of sensing patterns in the character recognition database 26 to identify the associated alphanumeric character, symbol, image, or other correlation associated with the tangible object 10 contacting the touch screen, display 24. The cross referencing may be performed by a cross referencing circuit 28 (see FIG. 5) in communication with the character recognition database 26. Along these lines, the cross referencing circuit 28 may receive a signal from the touch screen display 24 associated with the sensing pattern detected by the touch screen display 24. The cross referencing circuit 28 may then search through the character recognition database 26 to find that same sensing pattern stored in the database 26. Once that same sensing pattern is found, the cross referencing circuit 28 may determine the alpha-numeric character or symbol associated with that unique sensing pattern.

According to one embodiment, the unique sensing patterns are identified in one of three stages: Beginning Stage, Move Stage and End Stage. In the Beginning Stage, software records the sensing pattern, the location of the tangible object 10 on the touch screen display 24 and its orientation. If the tangible object 10 is moved across the touch screen display 24, then the Move Stage tracks movement of the contact points 20. Once the tangible object 10 is removed from the touch screen display 24, then the End Stage records the last known location with a tangible object 10 ID.

Once the cross referencing is complete, the touch screen display device 12 may generate an output. The output may be indicative of a match found between the sensing pattern of the tangible object 10 interfacing with the touch screen display 24, or indicative of no match found between the sensing pattern of the tangible object 10 and those stored in fire character recognition database 26.

With the basic concepts of the system and method described above, the following discussion will focus on various implementations of the present invention.

Various aspects of the present invention include detecting the sensing pattern associated with a tangible object 10 interlacing with the touch screen display 24 and then generating an output from the touch screen display device 12 in response to detection of the sensing pattern. For instance, a user may place a tangible object 10 associated with the number “1” on the touch screen display 24. The touch screen display device 12 detects the sensing pattern and then generates an output associated with the number “1,” such as saying the word “one” or by depicting the number “1” on the touch screen display 24. In this regard, the output generated by the touch screen display device 12 may be a visual output, an audible output, or a combination thereof. In this regard, the touch screen display device 12 may include a speaker 25 for emitting the audible output. The speaker 25 may be in communication with a central processing unit 27 (CPU), which controls operation of the device 12.

If the user places a tangible object 10 on the touch screen display 24 associated with a number other than “1,” the touch screen display device 12 may be configured to generate an alert to let the user know that the wrong object 10 was placed on the touch screen display 24. For instance, the touch screen display device 24 may generate a sound or display of “TRY AGAIN.”

The touch screen display device 12 may be configured to provide a notification to the user if the sensing pattern, associated with the tangible object 10 does not match the sensing patterns stored in the character recognition database 26, For instance, the character recognition database 26 stored on the user's touch screen display device 12 may only include sensing patterns associated with letters such that if the user places a number on the touch, screen display 24, the touch screen display device 12 will generate an output to notify the user that the sensing pattern associated with the number is not recognized (i.e., “object not recognized”). The touch screen display device 12 may give the user an option to update his character recognition database 26 to allow for use with additional characters, symbols, numbers, etc. In this regard, the touch screen display device 12 may be configured to connect with a remote character recognition database in response to no match being hound in the local character recognition database 26.

The above-described capability of detecting a tangible object 10 interfacing with the touch screen display 24 and subsequently generating an output associated with the detected tangible object 10 may be useful in a wide range of applications. One application may be related to a learning tool for teaching a child new words, letters, numbers, or other concepts. In this regard, the output generated by the tool in response to placing a tangible object 10 on the screen may provide both visual and phonetic instruction, to the child. For instance, in the embodiment depicted in FIG. 2, the user has placed a tangible object 10 associated with a lion on the touch screen display 24. In response thereto, the touch screen display device 12 generates an audible output of “LION” as well as a visual output of the word “ROAR!” Therefore, the child user may begin to develop an association between the animal and the sound the animal makes.

Another aspect of the present invention pertains to asking the user to place a specific tangible object 10 on the touch screen display 24. Once the tangible object 111 is placed onto the touch screen display 24, the touch screen display device 12 may generate an output, in the similar manner as described above. In one embodiment, the touch screen display device 12 generates a visual request. This visual request may be as simple as depicting a single letter, number, character, or other object on the screen which the user then matches by placing a tangible object 10 matching the depicted letter, number, symbol, or other character on the touch screen display 24. If the tangible object 10 matches the visual output on the touch screen display 24, the touch screen display device 12 may generate a visual output indicating that the user made the correct choice. Conversely, if the tangible object 10 does not correctly match the visual output, then the touch screen display device 12 may depict a subsequent visual output that indicates that the user made an incorrect selection.

It is also contemplated that the initial output or request may not only be in visual form, but may also be an audible output or request.

Referring back now specifically to FIG. 2, the touch screen display device 12 may output the word “LION” and/or depict a picture of a lion on the touch screen display 24. In response thereto, the user may place the tangible object 10 associated with the lion on the touch screen display 24. After decoding the tangible object 10, the touch screen display device 12 may output the word “ROAR!” in textual or audible form.

The ability to generate an output or request, detect a tangible object 10 interlacing with the touch screen display 24 and then subsequently generate a second output may be useful for several different learning tools or games. For instance, as mentioned above, that functionality may be used in a matching game wherein the initial output correlates to a first character (i.e. a number, a letter, a symbol, or other character), and the user's placement of the tangible object 10 on the touch screen display 24 and the subsequent detection thereof relates to the second character which is intended to match the first character. The second output generated by the touch screen display device 12 is indicative of a correct or incorrect match by the user.

It is also contemplated that the above-described functionally may be incorporated into a math game or tool wherein the first output or request relates to a mathematic equation wherein the solution, is missing, or wherein the equation includes a variable, or wherein the equation is missing a mathematical operator. The user would then place a tangible object 10 correlating to the missing element (i.e. the solution, the variable, the mathematical operator, etc.), and then the second output would be indicative or a correct or incorrect selection by the user.

For instance, FIG. 3 shows a mathematical learning tool using the tangible objects 10 along with the touch screen display device 12. In FIG. 3, the mathematical equation “1+2=3” is shown. In one implementation, the number “3” is the only portion of the mathematical equation represented by a tangible object 10. In other words, “1+2=” is depicted visually on the touch screen display 24. When the user correctly completes the equation, the touch screen display 24 may depict an image, such as “CORRECT.”

In another embodiment, the mathematical tool may allow the user to construct the equation for evaluation by the processing capabilities of the touch screen display device 12. For instance, the various components of the mathematical equation in FIG. 3 may be separate tangible objects 10 used to complete the equation. In this regard, the equation may be constructed from live separate tangible objects including the numbers “1,” “2,” and “3,” as well as the mathematical operators “+” and “=.”

Referring now specifically to FIGS. 4A and 4B, the functionality may also be embodied in a spelling game or tool wherein the first output relates to a word having a missing letter, which the user then places on the touch screen display 24. The second output is then indicative of a correct or incorrect selection by the user.

FIGS. 4A and 4B show a spelling tool wherein the word “hat” is partially spelled in FIG. 4A (specifically, the letter “t” is missing.). The user then places a tangible object 10 correlated with the letter “t” in the missing field to complete the word. When the word is correctly spelled, the touch screen display 24 may depict an image of a hat, as well as generate an audible output, of “hat.” The spelling tool may also give audible clues before the spelling is complete so as to help the user to complete the spelling of the word.

Other examples of games or loots which embody the above-described functionality include time learning tools wherein a user works out digital or analog equivalencies, money learning fools or games, wherein the user may recognize the value of coins or notes, or also calculating correct change. The above-described functionality may also be embodied in a true/false game wherein the first output relates to a question, and the user places a tangible object 10 correlating to a true or a false user input on the touch screen display 24, and the second output relates to the user being correct or incorrect Various aspects of the present invention may also relate to a grammar tool, wherein (be user completes or corrects grammatical omissions or mistakes associated with the first output. In this regard, the tangible objects 10 may relate to punctuation.

Another learning tool is a number line, wherein the first output includes a sequence of numbers having one or more omissions. The user then selects a tangible object 10 relating to the omission and places it on the touch screen display 24, which then generates a second output indicative of the user being correct or incorrect.

An additional learning tool may relate to decimal value, wherein the first output correlates to a number, and the user places a tangible object 10 associated with the decimal on the touch screen display 24. The second output then correlates to the number formed by the placement of the decimal point.

Another example includes a domino game, wherein the first output relates to a first domino tile. The user then selects a tangible object 10 correlating to a second domino tile associated with the first domino tile. The association between the first and second domino tiles may be governed by the traditional rules of dominos. The second output may be a visual depiction of a third domino tile or an indication that the second domino tile selected by the user may be placed next to the first domino tile.

Another aspect of the invention relates to using the tangible object 10 to delete a portion of the first output on the touch screen display 24 to create a new word, number, or other object. For instance, the first output may be the word “the.” The game may require the user to try and form another word from the letters depicted in the first word. Therefore, the user can block the letter “t” to form the word “he.” In this regard, the first output is the word “the” while the user's input relates to placing the blocking tangible object 10 over the letter “t.” As such, the touch screen display device 12 includes the capability to detect the position of the tangible object 10 relative to the letters forming the word “the.” If the placement of the tangible object 10 correlates to the position of the letter “t” in the word “the,” then the touch screen display device 12 understands that the user is trying to remove the letter “t.”

Another aspect of the invention may relate to a storytelling tool or game, wherein first output relates to the first part of the story, and the user's input (i.e. the placement of the tangible object 10 on the touch screen display 24) adds another part to the story. For instance, the first output may be “Jack kicked the hail into the . . . ” and then the user would have the option of selecting a destination for the ball. For instance, the user may have tangible objects 10 relating to “a pond,” “a field,” or “the goal.” Thus, by selecting one of the aforementioned tangible objects 10, the user may decide where Jack kicked the ball. Once the user makes the selection, and interlaces the tangible object 10 with the touch screen display 24, the second output may be a visual depiction of where Jack kicked the ball. For instance, if the user selected “the goal,” then the second output may include a picture of video of Jack kicking the ball into the goal.

Another implementation of the invention relates to a spinning game, wherein the first output relates to a circular chart, having various options depicted thereon in a radial arrangement. The tangible object 10 may relate to a spinner or arrow which may be placed over the circular chart depicted on the touch screen display 24 and spun to select one of the options displayed on the circular chart. When the spinner comes to rest, the touch screen display device 12 may be configured to detect the position of the arrow to make the corresponding selection.

According to another embodiment, the touch screen display device 12 is capable of detecting multiple tangible objects 10 or other inputs to the touch screen display 24. For instance, a user may place a plurality of tangible objects 10 on the touch screen display 24 in a numbering sequence. The touch screen display device 24 may be capable of generating an output (visual or audible) which indicates to the user whether the sequence is correct.

In another embodiment, the touch screen display device 24 may be configured to detect the spelling of a word and indicate to the user whether the spelling is correct or incorrect.

The touch screen display device 24 may also be configured to detect lettering sequences according to their position in the alphabet. Other examples include defection of mathematical equations, digital time, fractions, games including dominoes, chess, checkers, tic-tac-toe, or measuring tools wherein the user may measure the distance between two points, or an angle.

Alignment—It is contemplated that the touch screen display device 12 may be configured to detect whether a tangible object 10 has been placed on the touch screen display 24 in proper alignment with a defined reference position. For instance, in FIGS. 4A and 4B, the touch screen display device 12 may be capable of detecting whether the user places the “t” in proper alignment relative to the letters “h” and “a.” If the “t” is upside down, or rotated relative to the alignment of the “h” and “a”, the touch screen display device 12 may be able to detect such incorrect alignment and guide the user in moving the tangible object toward its correct position.

It is contemplated that various embodiments of the present invention may allow for synchronization of two or more touch screen display devices 12 to allow a user on a first touch screen display device 12 to see the tangible objects 10 placed on a second touch screen display device, and vice versa. In this regard, the tangible objects placed on the second touch screen display device may be virtual images depicted on the first touch screen display device, while tangible objects placed on the first touch screen display device may be depicted as virtual images on the second touch screen display device. The synchronization allows for interaction between two remote users, and may be achieved through network communication, such as communication over the Internet.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of using a tangible object with a touch screen display device, the tangible object having contact points defining a unique sensing pattern, the touch screen display device having a touch screen display, the method comprising the steps of:
providing a character recognition database having a plurality of stored sensing patterns associated with respective alphanumeric characters;
detecting the sensing pattern of a tangible object defined by the contact points of a tangible object contacting the touch screen display, wherein the detecting is performed by the touch screen display device;
cross referencing the detected sensing pattern with the plurality of sensing patterns in the character recognition database to identity the alphanumeric character associated with the tangible object contacting the touch screen display; and
generating an output by the touch screen display device in response to detection of the sensing pattern of the tangible object.

2. The method recited in claim 1 wherein the generating step includes emitting a visual output on the touch screen display of an image corresponding to the tangible object contacting the touch screen display.

3. The method recited in claim 1 wherein the tangible object corresponds to an alphanumeric character.

4. The method recited in claim 1 further comprising the step of displaying a first image on the touch screen display prior to the detecting step.

5. The method recited in claim 4 wherein the first image is an algebraic expression having a missing term, the method further comprising the step of determining whether the alphanumeric character associated with the tangible object corresponds to the missing term.

6. The method recited in claim 4 wherein the image is a word having a missing letter, the method further comprising the step of determining whether the alphanumeric character associated with the tangible object corresponds to the missing letter.

7. The method recited in claim 6 wherein the generating step includes emitting a visual signal including a second image associated with the word.

8. The method recited in claim 1 wherein the generating step includes emitting an audible output from the touch screen display device.

9. The method recited in claim 1 timber comprising the steps of:
defining a reference coordinate system relative to the touch screen display; and
determining whether the tangible object is aligned with the coordinate system.

10. The method recited in claim 1 further comprising the step of:
displaying a contact same on the touch screen display, the tangible object being detectable when contacting the touch screen display within the contact zone and non-detectable when contacting the touch screen outside of the contact zone.

11. The method of claim 1 further comprising the steps of:
displaying an image on the touch screen display; and
determining whether the sensing pattern of the tangible object contacting the touch screen display matches the image displayed on the touch screen display.

12. The method of claim 1 wherein the detecting step includes detecting conductive touch points on the tangible object using the touch screen display.

13. A method of using a tangible object with a touch screen display device, the tangible object having contact points defining a unique sensing pattern, the touch screen display device having a touch screen display, the method comprising the steps of:
providing a symbol recognition database having a plurality of stored sensing patterns associated with respective symbols;
detecting the sensing pattern of a tangible object defined by the contact points of a tangible object contacting the touch screen display, wherein the detecting is performed by the touch screen display device;
cross referencing the detected sensing pattern with the plurality of sensing patterns in the character recognition database to identify the symbol associated with the tangible object contacting the touch screen display; and
generating an output by the touch screen display device in response to defection of the sensing pattern of the tangible object.

14. A method of using a tangible object having a unique sensing pattern with a touch screen display, the method comprising the steps of:
providing a sequence database having a plurality of sensing pattern sequences stored therein, each sensing pattern sequence including a first sensing pattern and a second sensing pattern associated with respective alphanumeric characters or symbols;
detecting the sensing pattern of a first tangible object contacting the touch screen display;
detecting the sensing pattern of a second tangible object contacting the touch screen display; and
cross referencing the sequence database with the sensing patterns of the first and second tangible objects to determine whether the sequence patterns of the first and second tangible objects match any of the plurality of sensing pattern sequences stored in the sequence database.

15. The method recited in claim 14 further comprising the steps of:
emitting a first signal in response to determining that the sentience patterns of the first and second tangible objects match at least one of the plurality of sensing pattern sequences stored in the sequence database; and
emitting a second signal in response to determining that the sequence patterns of the first and second tangible objects do not match any of the plurality of sensing pattern sequences stored in the sequence database.

16. The method recited in claim 15 wherein at least one of the first and second signals is a visual signal displayed on the touch screen display.

17. The method recited in claim 15 wherein at least one of the first and second signals is an audible signal.

18. The method recited in claim 14 further comprising the steps of:
providing a first recognition database having a plurality of sensing patterns associated with respective alphanumeric characters and symbols;
cross referencing the sensing pattern of the first tangible object with the plurality of sensing patterns in the recognition database to identify the alphanumeric character or symbol associated with the tangible object; and
emitting a first signal in response to detection of the sensing pattern of the first tangible object.

19. The method recited in claim 18 former comprising the step of emitting an audible signal in response to identification of the alphanumeric object.

20. The method recited in claim 14 wherein the first and second tangible objects simultaneously contact the touch screen display.
